(19) United States
(12) Patent Application Publication
(10) Pub. No.: US 2011/0010219 A1
(43) Pub. Date: Jan. 13, 2011

(54) Method and system for determining adherence to a workflow

(75) Inventors: William Nathan Stearns, Arlington, TX (US); Paul Harold Leamon, McKinney, TX (US)

Correspondence Address: LAW OFFICE OF DAVID H. JUDSON, 15950 DALLAS PARKWAY, SUITE 225, DALLAS, TX, 75248, US

(73) Assignee: IEX CORPORATION, Richardson, TX (US)

(21) Appl. No.: 12/501,286

(22) Filed: Jul. 10, 2009

(51) Int. Cl. G06Q 10/00

(52) U.S. Cl. 705/9; 705/11

(57) ABSTRACT

An adherence system provides an entity (such as a supervisor) with the ability to define one or more acceptable agent state “rules” that are then monitored for compliance. A particular “rule” defines a sequence of user-configured or system-defined work item handling states and, optionally, a particular duration for a given state in the sequence. The rule typically also has associated therewith one or more user-configured or system-defined “actions” that should occur if the rule (which is sometimes referred to as a “policy”) is triggered. Using state information, the system monitors the various states of a particular agent against one or more rules. If the agent violates the rule (e.g., by moving in or out of a state out of sequence, by staying within a given state too long, or the like), a trigger event is initiated to indicate a potential or actual policy violation. The trigger event may then initiate a given action.

### BACKGROUND OF THE INVENTION

1. Technical Field

The present invention relates generally to computer-implemented agent or employee scheduling and management in a work center environment.

2. Background of the Related Art

Workforce management systems are well-known in the prior art. Such systems integrate many management functions, such as workforce forecasting and scheduling, skill planning and scheduling, multimedia contact management, and the like. A representative commercial system of this type is TotalView® workforce management, from IEX Corporation.

The performance of a contact center depends on how well agents follow their scheduled activities. When agents are in adherence the contact center's service level goals are more easily met, which increases customer satisfaction and shrinkage is decreased, which reduces staffing costs. Known workforce management systems (such as IEX TotalView) provide historical and real-time adherence (RTA) functionality. For example, the TotalView Adherence Suite provides real-time and historical adherence features enabling supervisors to easily monitor and analyze agent activity. The result is better planning, improved agent performance, lower costs and happier customers.

While workforce management functionality is known, agents in a contact center may still be able to manipulate the contact distribution system to avoid being identified to that system as the longest available agent. This enables an agent to avoid handling new contacts.

### BRIEF SUMMARY OF THE INVENTION

An adherence system provides an entity (such as a supervisor) with the ability to define one or more acceptable agent state “rules” that are monitored for compliance. A particular “rule” defines a sequence of user-configured or system-defined work item handling states and, optionally, a particular duration for a given state in the sequence. The rule typically also has associated therewith one or more “actions” that should occur if the rule (which is sometimes referred to as a “policy”) is triggered. Using state information, the system monitors the various work states of a particular agent against one or more rules. If the agent violates the rule (e.g., by moving in or out of a state out of sequence, by staying within a given state too long, or the like), a trigger event is initiated to indicate a potential or actual policy violation. The trigger event may then initiate a given action (typically as defined in the rule), such as one or more of the following: highlighting the occurrence on a real-time adherence display, writing an indication of the policy violation in the agent's historical activity record, triggering an automatic recording/capture of the agent's desktop and voice communications, alerting the agent's supervisor of the policy violation, generating one or more reports for both the agent and the supervisor illustrating the historical data capture and contact recording to verify if the policy violation was intentional or accidental, and so forth.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is an illustrative workforce management center in which the subject matter herein may be implemented;

FIG. 2 illustrates a representative supervisor display of a known adherence function in the workforce management system of FIG. 1;

FIG. 3 illustrates a workforce management system that has been enhanced to provide rules-based adherence according to the subject matter herein; and

FIG. 4 is a process flow illustrating how the adherence engine monitors a given rule and triggers one or more actions when a policy violation occurs.

### DETAILED DESCRIPTION OF AN ILLUSTRATIVE EMBODIMENT

In the following discussion, the subject matter is described in the context of a contact center environment, although it should be understood that the techniques described herein can be practiced in other types of environments such as, without limitation, back office environments, sales force environments, field service environments, manufacturing environments, airports, airlines, government agencies, casinos, banks, retail stores, warehouses, and other types of environments wherein entities (agents, employees, contractors, other persons, or the like) work according to assigned schedules. In a contact center, the environment generally comprises an automatic call distributor (ACD), and/or one or more multimedia server(s) coupled to a host computer via a computer network. The ACD is coupled to a communications network. The ACD and multimedia server(s) generally provide routing capabilities for incoming voice calls (via the ACD) and other contacts (via the multimedia server), such as faxes, email, voice mail, web requests, web call-back requests, web chats, web voice calls, web video calls, and the like. For ease of discussion, the persons who work at the contact center are referred to herein variously as “agents” or “employees.” These designations are used interchangeably within the following description. Of course, this nomenclature is not meant to be taken to limit the invention in any way, as the word “employee” or the word “agent” is meant to be broadly construed to include any person regardless of a particular legal status. An agent need not actually handle contacts, of course. A “schedule” is any ordered list of times at which given events or activities are planned to occur.

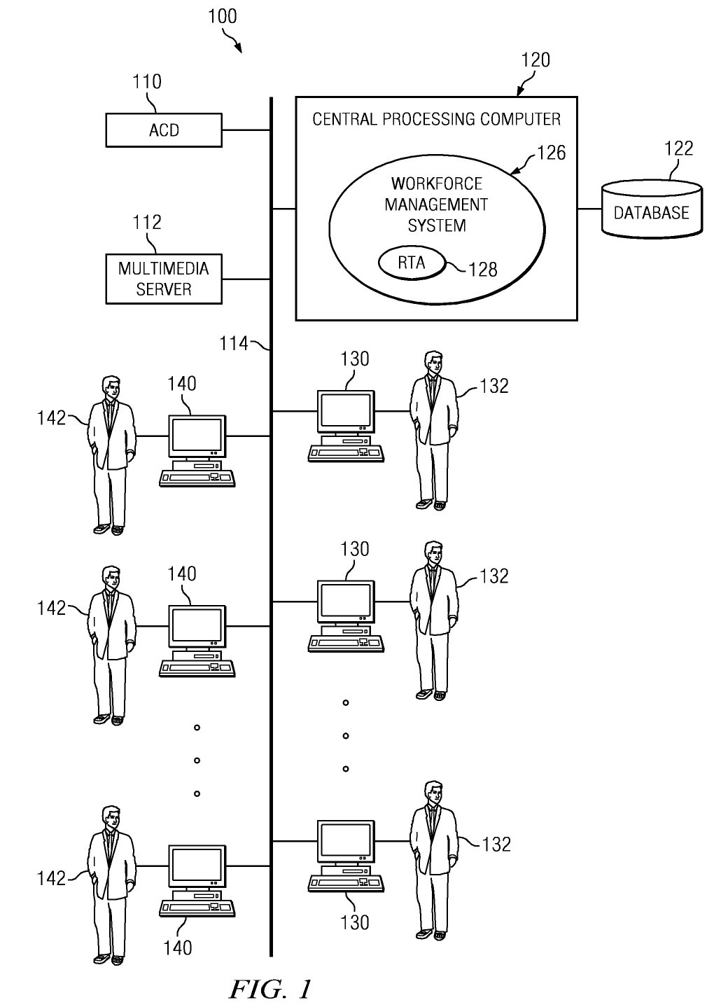

Referring to FIG. 1, the reference numeral 100 generally designates a workforce contact center environment. As noted above, the environment 100 generally comprises an automatic call distributor (ACD) 110 and a multimedia server 112 coupled to a central processing computer 120 via a network 114, such as a wireline and/or wireless local area network (LAN), a wireline and/or wireless wide area network (WAN), the Internet, an Intranet, or the like. As also described above, the ACD 110 and multimedia server 112 generally provide routing capabilities for incoming voice calls (via the ACD) and other contacts (via the multimedia server). The function and operation of the ACD 110 and multimedia server 112 are considered to be well-known to a person having ordinary skill in the art. The central processing computer 120 receives from the ACD 110 and the multimedia server 112 periodic contact information, such as the number of contacts handled (“in contacts”), the amount of time an agent spends on incoming contacts (“talk time”), the amount of time an agent spends after the talk time for administrative duties related to contact resolution (“work time”), the amount of time an agent spends in talk time and work time (“total time”), the amount of time an agent spends available to take a call or handle a contact (“available time”), the amount of time an agent spends in an auxiliary state and/or is unable to take a call (“aux time” and/or “break time”), the number of outgoing contacts made by the agent (“out contacts”), the time spent on the outgoing contacts (“out time”), the elapsed time spent logged into the system (e.g., ACD or multimedia server) (“system time”), and the like, and preferably stores the information in a database 122 coupled to the central processing computer 120, preferably at 15-30 minute intervals or real time. A workforce management system 126 provides workforce forecasting and scheduling, skill planning and scheduling, multimedia contact management, and the like. While the database 122 is shown external to the computer, one skilled in the art will appreciate that the database 122 may be included within the central processing computer 120, or that the data be retrieved from any other location when needed. The central processing computer 120 is also coupled via the network 114 to one or more agent workstations 130 and to one or more supervisor workstations 140, which provide an interface between the workforce management system 126 and one or more agents 132 and supervisors 142, respectively. The agent workstations 130 and the supervisor workstations 140 are preferably configured to access the central processing computer 120 through the network 114 via a browser, such as a Java-enabled web browser, a Windows-based application, a Java application or ActiveX control, or any other client technology or functionality. As is well-known, agents 132 access, via the telephone (not shown) and agent workstation 130, the ACD 110, multimedia server 112, or other contact servers (not shown) to aid in contact resolution. As the agents 132 service the contacts, the ACD 110 and the multimedia server 112 collect performance and other data for each of the agents 132. The performance data of the agents 132, such as the in contacts, talk time, work time, total time, available time, aux time, out contacts, out time, system time, and the like, are sent periodically by the ACD 110 and the multimedia server 112 to the central processing computer 120 and, preferably, stored in the database 122.

The workforce management (WFM) system 126 is a suite of one or more software-driven systems that provide workforce forecasting and scheduling, skill planning and scheduling, multimedia contact management, and the like, and that provides an interface to the database 122. A representative commercial system of this type is TotalView® workforce management, from IEX Corporation.

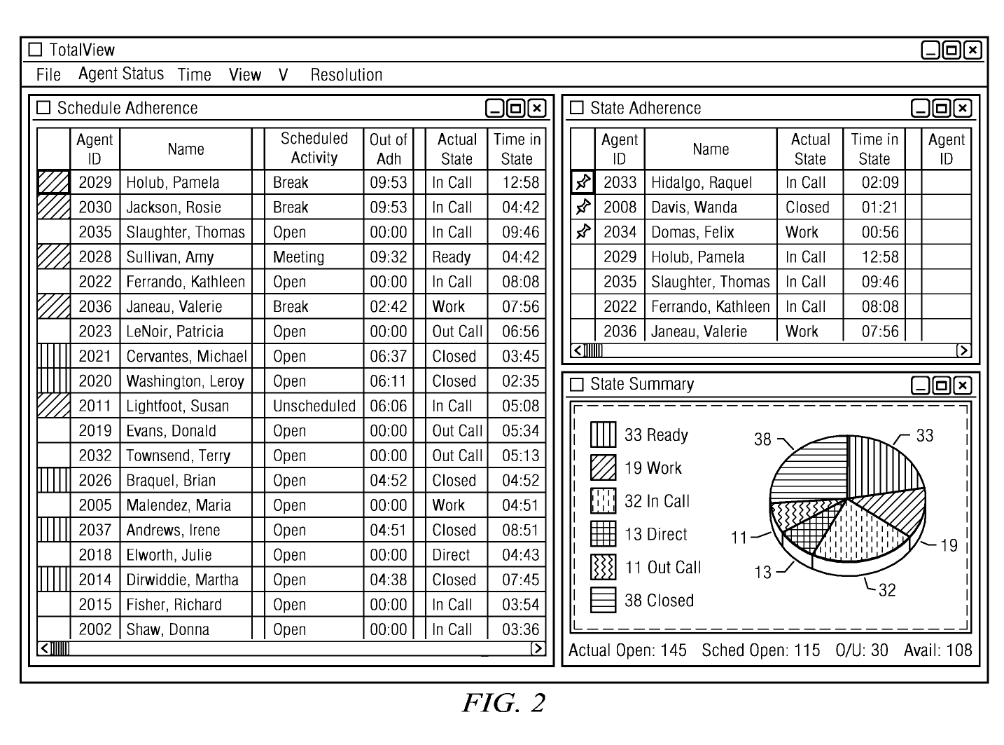

A known workforce management system also provides a real-time adherence (RTA) function, illustrated as RTA 128. RTA may be implemented in hardware, in software, in a combination of hardware and software, or the like. The RTA function compares an agent's scheduled activity to current activity, using real-time data streams from ACDs and multimedia servers to provide up-to-the-moment (or, more generally, “current”) agent state information. With this information supervisors are able to make sure agents keep to their schedules throughout the day. The RTA 128 provides a supervisor display screen (such as shown in FIG. 2) that combines information on agent adherence with schedules, agent adherence to work-state time limits, and an overall summary of agents in each state into one or more display screens (or tabs), providing supervisors an at-a-glance indication of agent performance. The system may be implemented using web-based technologies or legacy applications. If an agent is not on schedule, the agent's name is highlighted to alert the supervisor so that action can be taken to correct the situation, if necessary. Supervisors can also print the current real-time adherence screen so that issues can be documented or addressed in coaching sessions. Preferably, the supervisor display updates data as it is received, eliminating the need for manual screen refreshes. The display enables supervisors to set their own adherence tolerances and state displays, and it provides multiple sorting options to automatically sort displayed information by user-defined criteria so that the most critical adherence issues are displayed first. Agents that need extra monitoring can also be tagged to keep them at the top of the list, independent of other sorting criteria. With existing WFM RTA systems, adherence can be viewed from any workstation for an individual site or for an entire enterprise. The RTA display may also show an agent's schedule for easy comparison or modification. A known RTA function of this type is implemented in IEX TotalView®, which is a commercial system marketed by IEX Corporation, Richardson, Tex. RTA can be implemented with agents within a physical contact center and/or with respect to agents working outside that environment (such as agents who work from home).

Despite the significant benefits afforded by RTA functionality, agents in a contact center are able to manipulate the contact distribution system to avoid handling contacts. In particular, the agent is able to designate his or her state on the contacts distribution system, which is a subsystem implemented in an automated call distributor (ACD) or the like. The state selected by the agent indicates if the agent is available to handle a contact. Although the contact center performance management function uses the total time in each state to create a key performance indicator (KPI) as a means to coach agents to improve productivity, some operating states are considered productive even though the state keeps the agent from receiving contacts. Unfortunately, the sequence and duration of each instance of each state is not known simply by reviewing total time in each state as a summary KPI. Therefore, some agents learn that with the correct sequence and duration of individual states, contacts can be avoided, even though specific KPIs may not indicate an issue with the agent's performance.

This “gaming” of the content distribution system may work as follows. An agent logs into the ACD and selects an “available” state. If no calls are in queue, the agent will remain in the “available” state. When a call becomes available, the call is connected to the agent who has been in the “available” state the longest. This is a known ACD function. When a call is connected to an “available” agent, the agent's state changes, e.g., to an “inbound” state, meaning that the agent is handling an inbound call. When the call terminates, the agent selects the “after call work” state to complete call wrap up. After the call wrap up activities are complete, the agent should select the “available” state and prepare to receive another call. In practice, however, the agent can select the “available” state, or an “AUX/Idle” state, or an “outbound” state, or another state immediately after the “after call work” state. These other states are often considered “productive.” To avoid additional calls then, the agent learns how to use the state changes to keep him/her from being identified to the contacts distributed system as the “longest available agent.” For example, the agent may select “available,” and then immediately select “outbound” without fully dialing a number. After a few seconds in the “outbound” state, the agent may select the “available” state, and then immediately select the “after call work” state. These sequences of state changes keep the agent from registering as the longest available agent, because they are in the available state for only a brief time.

The subject matter herein addresses this problem.

To that end, the adherence system provides an entity (such as a supervisor or other user) with the ability to define one or more acceptable agent state “rules” that are then monitored for compliance. Preferably, a given “rule” defines a sequence of user-configured or system-defined states and, optionally, a particular duration for a given state in the sequence. The rule typically also has associated therewith one or more user-configured or system-defined “actions” that should occur if the rule (which is sometimes referred to as a “policy”) is triggered. Using state information, the system monitors the various states of a particular agent against one or more rules. If the agent state violates the rule (e.g., by taking an action out of sequence, or by taking longer than the state provides, by taking less than a defined amount of time, or some combination thereof), a trigger event is initiated to indicate a policy violation. The trigger event may then initiate a given action (typically as defined in the rule), such as one or more of the following: highlighting the occurrence on an adherence display, writing an indication of the policy violation in the agent's historical activity record, triggering an automatic recording/capture of the agent's desktop and voice communications, alerting the agent's supervisor of the policy violation, generating one or more reports for both the agent and the supervisor illustrating the historical data capture and contact recording to verify if the policy violation was intentional or accidental, and so forth.

The described technique enhances an adherence system or function by monitoring the sequence (and, optionally, duration) of each state change initiated by the agent. When a user-specified or system-defined sequence and/or duration of each state is detected, the policy violation is noted and one or more actions taken.

The functionality described herein may be built into (or otherwise native to) a workforce management system or provided as an adjunct or value-added feature of an existing system. Preferably, and as noted above, a given rule is user-configured and/or system-defined, and different agents (or subsets of agents) may be managed using different rules or rule sets. Of course, a particular rule (or sequence of states or state durations) will depend on the workforce management system application for which compliance is being monitored.

The “adherence” may sometimes be referred to herein as “real-time.” The term “real-time” as used herein should not be taken to be limited to a particular instant in time, as the wording is intended to be flexible and cover a particular point-in-time or a given temporal duration.

The following illustrates a set of “acceptable” rules for a set of agents. A particular rule set may be defined by a user or the system for a particular set of agents, for a particular set of agents within a contact center or across a set of contact center locations, for the entire contact center as a whole, or some other convenient or desired grouping. Thus, the following is a set of rules that are considered to be “acceptable” state sequences:

Acceptable State Sequences:

1. available, inbound, after call work, available [action: update RTA display]

2. available, inbound, outbound, after call work (<5 minute), available [action: alert]

3. available, inbound, available [action: capture display and voice for a given time period, or until a given occurrence, etc.]

4. available, inbound, after call work, aux/idle [action: flag]

5. available, after call work <x seconds, available [action: alert]

Note that the first, third and fourth sequence do not include any temporal limitations, however, sequences two and five indicates that, while after call work (ACW) is acceptable, ACW must be less than a given duration. In this example, the first rule includes an associated action, namely, to update the supervisor's display. A violation of the second rule triggers the sending of an alert, e.g., by email, SMS, MMS, through a WFM system update, or the like. A violation of the third rule triggers an agent screen capture and/or voice recording (e.g., for a given time, or until a given occurrence), and so forth. Of course, these are merely representative actions, and a particular rule may have associated more than one action, or no action, as the supervisor (or the system) may designate. When alerts are used, preferably they are accumulated and stored in a database. More generally, it may be desired to always “flag” when a given state sequence rule is not honored.

In one embodiment, the adherence function monitors state data (real-time or otherwise) against the “acceptable” state sequence. This is not a limitation, however. In an alternate embodiment, the supervisor (or the system) may consider all states acceptable and simply monitor agent state data against a set of “unacceptable” state sequences. In other words, the function may be implemented by defining a set of one or more acceptable sequences, a set of one or more unacceptable sequences, or some combination of the two approaches.

The following represent typical “unacceptable” state sequences that may be defined by a user and/or the system:

Unacceptable State Sequences:

1. Available, aux/idle, available [action: alert, screen capture]

2. Available, after call work, aux/idle, outbound, available [action; update display]

3. Available, aux/idle, outbound, available [action: alert]

4. Available, outbound (<1 minute), available [action: flag, otherwise no action]

Of course, the above are merely representative of one or more state sequences. Preferably, the one or more sequences are designed using any convenient display interface, such as a menu-driven approach, a simple command line interface (CLI), or the like.

As noted above, the adherence determination may be carried out either in a “positive” sense (meaning that the function monitors state data and compares it against an “acceptable” sequence) or a “negative” sense (meaning that the function monitors state data and compares it against an “unacceptable” sequence). Thus, in determining whether an agent's activity is “consistent with” a given sequence, such terminology is deemed to cover both the “positive” and “negative” evaluation methods.

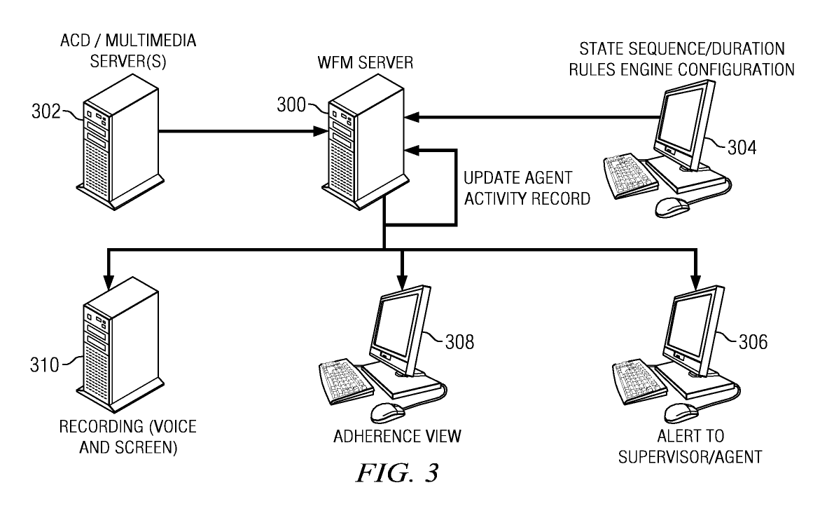

FIG. 3 illustrates a representative workforce management system in which the disclosed rules-based adherence function is implemented. The workforce management system includes a workforce management (WFM) server 300, which receives data from an ACD/multimedia server 302. WFM 300 provides the basic functionality of the workforce management system, and it typically comprises a set or suite of applications. A workstation 304 provides the operator (a supervisor or other entity) with suitable input/output devices and mechanisms for interfacing to the WFM system and, in particular, with an interface for defining and managing the adherence rules. The workstation 304 typically is a conventional personal computer that interfaces over a network (LAN, WAN, public, private, or the like) to the remainder of the WFM system. In one convenient embodiment, the workstation 304 implements a rule engine by which the operator defines a set of one or more rules that are then monitored by the WFM server 300 against the state data provided by the ACD/multimedia server 302. If a policy is violated, one or more actions are taken. As seen in FIG. 3, one action may trigger a real-time alert to the supervisor. This is illustrated at 306. In the alternative, the action may trigger an update to the real-time adherence screen 308. Another alternative is to initiate an agent screen capture or recording. This action may be done using a recording function system in a recording system 310. As noted above, these actions are merely representative.

In a preferred embodiment, the workstation 304 provides a configuration screen by which a user configures a real-time state sequence/duration configuration. Although any convenient user interface may be implemented, a convenient approach is to enable the user to perform an auto search of historical state sequences to identify and present sequences in a choice list (e.g., a dropdown list). The interface may enable the user to import state sequences from a database, from the Internet (via a URL), or the like. The user may select a sequence from a choice list, import a new sequence, download a sequence, or he/she can define a new sequence and/or state duration, e.g., from a set of GUI functions, e.g., fill-in data fields, listbox entries, radio buttons, check boxes, or the like. In the alternative, the state sequence may be derived from historical data.

Preferably, a permitted user may be provided the opportunity to edit a particular state sequence to create a custom state sequence. This may be accomplished using conventional display/editing functionality.

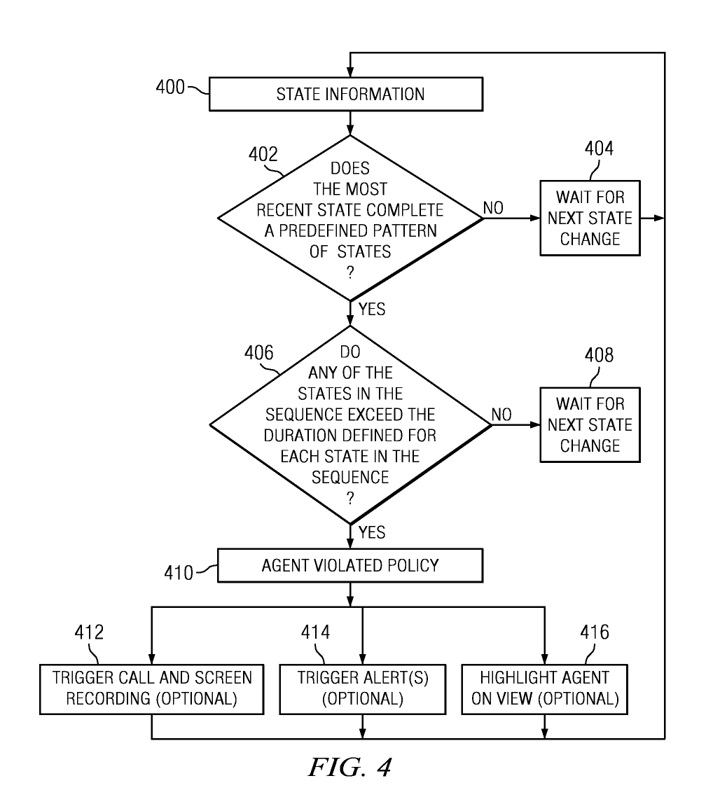

FIG. 4 illustrates a representative process flow of the rules-based adherence functionality. This process assumes that the user and/or the system has configured or defined at least one or more state sequences such as described above. As noted, the system may work with either a set of “acceptable” sequences that must be found in order to avoid triggering a policy violation, or a set of “unacceptable” sequences that, once identified, trigger the policy violation indication, or some combination of the above.

For purposes of illustration, it is assumed that a set of acceptable sequences has been defined and that the first rule in the sequence is being evaluated. The particular rules in a sequence may be grouped or ordered in any convenient manner.

The process assumes the existence of real-time state information. The following steps are then carried out for each state in the sequence in question. At step 400, the state information is provided to the system, which then performs a test at step 402 to determine whether a most recent state (in which the agent is in currently) completes a predefined pattern of states as defined in the sequence in question. If the answer to the test is no, the routine waits for a next state change to occur at step 404. If, however, the most recent state completes the predefined pattern of states as defined in the sequence in question, the routine continues at step 406 to perform a second test. At this step, the routine determines whether any of the states in the sequence have a given relationship (<, >, etc.) with any duration condition defined for each state in the sequence. If not, the routine continues at step 408, once again waiting for the next state change. If, however, the outcome of the test at step 406 is positive, then the system provides an indication at step 410 that a policy violation has occurred; the event also may be stored/flagged in a system or external database. In this example, the policy violations may trigger one or more of the following: an agent screen capture and/or recording 412, an alert 414, and/or an adherence display screen update 416. As indicated in the drawing, after each of steps 404, 408, 412, 414 and/or 416, as the case may be, control returns to step 400.

One of ordinary skill in the art will recognize that if a particular sequence does not include any temporal condition on any state within the sequence, then step 406 may be omitted. Also, instead of testing the particular sequence for the states, the routine in FIG. 4 may simply perform the temporal duration test within the context of determining whether a particular state is “correct.” Thus, in the latter case a particular state within a sequence may be flagged (or otherwise) found to be correct if any duration parameter is not violated; then, the next state is evaluated, and so forth.

As one of ordinary skill will appreciate, the subject matter herein combines and then extends existing ACD and WFM technologies to monitor real-time state changes with a user-configured or system-defined rules engine that analyzes state sequences (and state duration if appropriate), and triggers one or more actions in the event of a rule (policy) violation. The rules engine preferably is implemented in software, as program code executable in a machine, to carry out the described functionality.

A “sequence” of work item handling states may be generalized as a “workflow.”

The subject matter of this disclosure may be added to an existing the WFM system as add-on option. It also provides a new tool for managing agent performance (performance management) and agent quality of service (quality management).

More generally, a workforce management system environment in which the method and system of the invention may be implemented includes a set of computing-related entities (systems, machines, processes, programs, libraries, functions, or the like) that facilitate or provide an agent-supervisor network. In a typical implementation, the environment typically comprises a set of computers. A representative machine is a client workstation or a network-based server running commodity (e.g. Pentium-class) hardware, an operating system (e.g., Linux, Windows 2000, OS-X, Ubuntu, or the like), an application runtime environment (e.g., Java), and a set of applications or processes (e.g., Java applets or servlets, linkable libraries, native code, or the like, depending on platform) that provide the functionality of a given system or subsystem. A client machine typically includes a Web browser (Internet Explorer, Netscape Navigator, Apple Safari, Mozilla Firefox, or the like) or other rendering engine. A Web browser typically includes or supports media players and other plug-ins. Conveniently, information may be provided on an agent workstation using a Java-based applet or application.

It is further noted that, unless indicated otherwise, all functions described herein may be performed in either hardware or software, or any combination thereof. In a preferred embodiment, the functions are performed by one or more processors executing given software.

Variants and Extensions

While the subject disclosure has been described in the context of an embodiment wherein a display interface is used to define and manage one or more state rules, this is not a requirement. The rules may be hard-coded into the WFM server functionality. In the alternative, one or more rules may be input and applied via a programmatic entry.

Moreover, there is no requirement that any particular sequence include a set or minimum number of states; indeed, a particular sequence may comprise just a single state having an associated duration.

According to another extension, it is not required that the system implement sequences associated with live or active contact center “agents” as the functionality may be used to define any workflow sequence associated with other individuals or entities against which performance or other data is compared.

There may be many variations to the types of rules and/or parameters within a given rule. Thus, for example, a temporal parameter may be enforced with respect to a particular state to ensure that the state lasts a given period of time. For example, some agents go into an after call work state for only a few seconds in an attempt to avoid being assigned the “longest available” status. This strategy can be addressed by a rule such as “issue an alert if ACW <5 seconds” or the like.

There may be a rule for a single state, e.g., inbound call (talk time); in this example, the rule may issue an alert if the inbound call state is greater than, say, 10 minutes. A rule may also incorporate more complex parameters or semantics, e.g., “ACW must be <10% of Talk Time” or the like.

There may be a rule associated with a contact type if that information is available to the system. Thus, for example, a first rule may issue an alert if “Sales inbound call time is >10 minutes while a second rule may issue an alert if “Service inbound call time is >15 minutes.” Of course, these are merely representative.

A particular rule may also determine when the defined action ends, e.g., in time or based on another event. This operation may be applicable, for example, for screen and voice recording actions, or the like.

According to another variant, a particular alert may be generated (when a state or sequence is violated) from within the workforce management (WFM) system.

The system and techniques described herein may be used to enforce work states that involve both telephone and desktop applications. In other words, a particular state may be determined to be acceptable or unacceptable based on a status other than based just on what the agent is or is not doing with respect to the telephone. Thus, a rule may be created with respect to some aspect of an agent's desktop and, in particular, one or more applications executing on the desktop. For example, a given rule may be generated to issue an alert if the telephone state is “ACW and the desktop state is application X or Y”. In this embodiment, the system receives state data from multiple sources, e.g., the ACD, a multimedia server, a dialer, the agent desktop, and the like, and the system enforces a given rule against a work state that involves both the telephone and one or more applications.

As a further extension, the system and techniques described herein may also be implemented with respect to back office work, where states are not telephone states but steps in desktop work involving one or more applications. For example, consider a mortgage processing facility where employees work process a file through a series of applications, e.g., a mortgage application, a loan application, and so on. Using the techniques described herein, a particular rule may be generated to issue an alert if “data entry to the mortgage application >10 minutes,” and so forth.

As still another extension, the techniques described above may take into consideration performance management “key performance indicators” (KPIs). As an example, the reports generated may store such data as “total number of infractions,” “infractions” by type, and the like. More generally, the techniques described herein are useful to facilitate key performance indicator (KPI) tracking.

The techniques described herein may be implemented in association with a discovery process that facilitates the definition of a given workflow. For example, such a process may monitor agents as they perform a given activity (or set of activities) to enable the building of a process flow diagram for one or more “acceptable” or “desired” paths from a beginning of the process through the end of the process, deviations from those paths, and metrics and/or attributes of a given path. The process flow diagram may then be used to define the set of states for the workflow and against which the real-time adherence data is then compared in the manner previously described.

A workflow may comprise a sequence of states associated with multiple adherence data streams, i.e., data streams from various sources in or associated with an enterprise work environment. Thus, for example, the adherence data streams may be provided from one or more of the following: an ACD, a dialer, a desktop business application, a chat program, an email application, an order entry program, a web browser, and the like). Thus, a given workflow may associate multiple adherence data streams. A defined state in the workflow may cross over or combine information from one or more of such data streams.

As mentioned above, and because the disclosed techniques are designed to be implemented with multiple types of data streams, as used herein a “workflow” should be broadly construed to refer to a sequence of two or more “work item” handling states, where a given “work item” may be of any type such as: a voice call, a fax, an email, a voice mail, a web request, a call-back request, a chat, a web voice call, a video call, a business process request, a business application function, etc.

While typically an agent's activities are compared to a workflow during a given work period, the techniques described herein may also be implemented after the work period is over, e.g., based on recorded or historical data. This enables the user of the system to analyze adherence to workflow(s) after-the-fact.

Preferably, the processing herein is carried out with at least one of the processing steps being performed in a computer so as to implement a machine-implemented method. Typically, the computer is a “special purpose” or “particular” machine such as a WFM server 120.

In one embodiment, the disclosed subject matter is implemented in conjunction with a back office operation, such as the communications and fulfillment activities for a given business enterprise. To this end, a WFM platform is extended with a suite of software tools that enable data collection and analysis from the back office and provides that data to the WFM system for forecasting, scheduling, change management and performance management.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

The disclosed subject matter invention can take the form of an entirely hardware embodiment, an entirely software embodiment, or an embodiment containing both hardware and software elements. In one preferred embodiment, the rule definition interface and data state sequence comparisons are implemented in software executing in one or more server machines. Each server may have one or more processors. The disclosed subject matter (or portions thereof) may take the form of a computer program product accessible from a computer-usable or computer-readable medium providing program code (instructions) for use by or in connection with a computer or any instruction execution system. A computer-usable or computer readable medium can be any device or apparatus that can store the program for use by or in connection with the instruction execution system, apparatus, or device. The computer-usable or computer readable medium is tangible. The medium can be an electronic, magnetic, optical, or the like. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

While given components of the system have been described separately, one of ordinary skill will appreciate that some of the functions may be combined or shared in given instructions, program sequences, code portions, and the like.

Having described our invention, what we now claim is as follows.

1. A computer-readable medium having stored thereon instructions that, when executed, direct a workforce management (WFM) system to:
receive a workflow for an agent comprising a sequence of work item handling states;
during a given work period, compare an agent's activity against the workflow;
determine whether the agent's activity is consistent with the workflow; and
if the agent's activity is not consistent with the workflow, taking a given action.

2. The medium as described in claim 1 wherein the agent's activity is consistent with the workflow if each state is carried out in the sequence of states.

3. The medium as described in claim 1 wherein at least one state in the sequence of states includes a temporal rule associated therewith.

4. The medium as described in claim 3 wherein the agent's activity is consistent with the workflow if each state is carried out in the sequence of states and the temporal rule is not violated.

5. The medium as described in claim 1 wherein the workflow is one of: user-configured, and system-defined.

6. The medium as described in claim 1 wherein the given action is one of:
user-configured, and system-defined.

7. The medium as described in claim 1 wherein the given action is one of:
updating an adherence display, writing an indication of a policy violation in a data record, triggering a recording or data capture of an agent's desktop or voice communications, alerting a supervisor, and generating a report.

8. The medium as described in claim 1 wherein the agent is a contact center agent and the workflow is a set of call handling states.

9. The medium as described in claim 1 wherein the workflow defines one of:
an acceptable set of states, and an unacceptable set of states.

10. A machine-implemented method for workforce management, comprising:
for each of a given set of work item handling agents:
defining a set of one or more rules, each rule comprising a sequence of work item handling states;
during or following a given work period, comparing an agent's activity against each rule in the set of one or more rules;
determining whether the agent's activity is consistent with the rule; and
if the agent's activity is not consistent with the rule, taking a given action;
wherein at least one of the steps is performed in a workforce management (WFM) server.

11. The method as described in claim 10 wherein the agent's activity is consistent with the rule if each state is carried out in the sequence of states.

12. The method as described in claim 10 wherein at least one state in the sequence of states includes a temporal rule associated therewith.

13. The method as described in claim 12 wherein the agent's activity is consistent with the rule workflow if each state is carried out in the sequence of states and the temporal rule is not violated.

14. The method as described in claim 10 wherein the rule is one of: user-configured, and system-defined.

15. The method as described in claim 10 wherein the given action is one of:
user-configured, and system-defined.

16. The method as described in claim 10 wherein the given action is one of:
updating an adherence display, writing an indication of a policy violation in a data record, triggering a recording or data capture of an agent's desktop or voice communications, alerting a supervisor, and generating a report.

17. A computer-readable medium having stored thereon instructions that, when executed, direct a data processing system to:
receive a workflow comprising a sequence of work item handling states, wherein at least one work item handling state is associated with one of: a computer telephony application, and a desktop application;
during or following a given work period, compare an agent's activity against the workflow;
determine whether the agent's activity is consistent with the workflow; and
if the agent's activity is not consistent with the workflow, taking a given action.

18. The medium as described in claim 17 wherein the desktop application is one of: email, chat, CRM, order entry, and a business application.
